(19) United States
(12) Patent Application Publication
(10) Pub. No.: US 2008/0273954 A1
(43) Pub. Date: Nov. 6, 2008

(54) Apparatus for lifting, lowering, positioning, supporting and transporting a tire

(76) Inventor: Jacobus Jozef Kroeg, Kingston (CA)

Correspondence Address: JAMES RAY & ASSOCIATES, 2640 PITCAIRN ROAD, MONROEVILLE, PA, 15146, US

(21) Appl. No.: 12/150,921

(22) Filed: May 1, 2008

Related U.S. Application Data
(60) Provisional application No. 60/927,227, filed on May 2, 2007.

(51) Int. Cl. B60B 30/00

(52) U.S. Cl. 414/428

(57) ABSTRACT

An apparatus for lifting, lowering, supporting, positioning and transporting a tire is provided and includes a first generally horizontal frame member manufactured from a first predetermined material and having a first predetermined size and a first predetermined shape. A first generally vertical frame member has a first end and a second end and is manufactured from a second predetermined material and has a second predetermined size and a second predetermined shape. The first end of such first generally vertical frame member is operably connected to the first generally horizontal frame member at at least one predetermined location thereon. A pair of arm members each have a first end and a second end and are manufactured from a third predetermined material and have a third predetermined size and a third predetermined shape. The first ends of such arm members are adjustably connectable to the first generally horizontal frame member at predetermined locations thereon.

### CROSS REFERENCE TO RELATED APPLICATION

This patent application is related to and claims priority from U.S. Provisional Patent Application Ser. No. 60/927,227 filed May 2, 2007.

### FIELD OF THE INVENTION

The present invention relates, in general, to tools and, more particularly, this invention relates to tools for assisting a user in lifting heavy and awkwardly shaped objects.

### BACKGROUND OF THE INVENTION

Prior to the conception and development of the present invention, lifting tools, as are generally well known in the prior art, have been used to aid people in lifting objects. However, some objects, such as tires and the like, have awkward shapes making them difficult to lift even using a lifting tool. Moreover, tires, in particular, are often lifted to be mounted on vehicles necessitating not only lifting of the tire but also positioning of the tire to align it with the surface upon which it will be mounted. Therefore there is a need for a device which will enable a user to lift and position heavy and awkwardly shaped objects such as tires easily.

Specifically of interest to the present invention are the following: Garnett, U.S. Pat. No. 6,095,745, discloses a caddy apparatus for lifting and carrying a vehicle tire. The device includes a cart frame and a wheel maneuvering structure having a tilt frame and lift carriage slideably mounted on the tilt frame; a pivot mounting of the tilt frame on the cart frame; a tire lift carriage slideably mounted to the tilt frame of the wheel maneuvering structure for engaging and retaining a vehicle tire; and a tire lift carriage lifting and lowering mechanism, preferably employing a hydraulic pump and cylinder.

Kassebaum, U.S. Pat. No. 5,362,194, discloses a lifting and tilting device for facilitating removal, repair and re-installation of large commercial and recreational vehicle wheels comprising a frame supported by wheels, a fork supporting tines, and a hydraulic jack interposed between the frame and the fork. The fork, in addition, includes a kicker. As one actuates the jack, the fork is vertically raised from a wheel receiving position to a predetermined height. Once the fork reaches this predetermined height, the kicker, upon further actuation of the jack, operates to tilt the fork and tines upwardly and outwardly to move the wheel carried thereon into an inclined work position.

Niewald, et al, U.S. Pat. No. 4,571,142 discloses a mechanism for lifting vehicle tires which includes a base framework which is movable along the ground. An elongated mast extends upwardly from the base framework and has a masthead which is movable along the mast. An arm extends outwardly from the masthead and has at its outer end two tandem wheels which are aligned in the same plane and have rotational axes parallel to one another in a horizontal plane. A jack on the base framework is operably connected to the masthead and allows selective lifting and lowering of the masthead. The tandem wheels engage the top inside of the rim of the vehicle tire and cause the vehicle tire to be lifted when the masthead is lifted. When lifted, the tire may be rotated because it is supported only by the rotatable tandem wheels. The tire may also be transported when in a lifted position.

Hawkins, U.S. Pat. No. 4,050,597, discloses a wheel dolly wherein threaded adjustment means are provided for adjusting the level of an inner substantially L-shaped wheel carrying frame within an outer substantially L-shaped wheeled support frame so that the level of the inner frame may be independently adjusted when elevated as into truck tire engaging position so that the proper level may be achieved for removing and replacing truck tires and the like.

Cofer, U.S. Pat. No. 3,951,287, discloses a dolly to receive and hold tires or wheel assemblies for removing or replacing same on a vehicle such as a tractor having a frame with an open front. A lift assembly is mounted on the frame. Stanchion members are secured to the lift assembly and extend upward. A cross member is mounted on the stanchion members. This cross member is movable relative the frame. Lift arms are mounted on the cross member and extend toward the front.

Barosko, U.S. Pat. No. 3,145,859, discloses a dolly type apparatus for transporting heavy objects such as wheel and tire assemblies. The dolly is meant to adjust the position of the wheel and tire assemblies in all directions.

### SUMMARY OF THE INVENTION

The present invention provides an apparatus for lifting, lowering, supporting, positioning, and transporting a tire. Such apparatus includes a first generally horizontal frame member having a first end and a second end and being manufactured from a first predetermined material and having a first predetermined size and a first predetermined shape. A first generally vertical frame member having a first end and a second end is manufactured from a second predetermined material and has a second predetermined size and a second predetermined shape. The first end of such first generally vertical frame member is operably connected to the first generally horizontal frame member at at least one predetermined location thereon. A pair of arm members each having a first end and a second end are manufactured from a third predetermined material and have a third predetermined size and a third predetermined shape. Such arm members are adjustably connectable at each of such respective first ends thereof to the first generally horizontal frame member at predetermined locations thereon.

### OBJECTS OF THE INVENTION

It is, therefore, one of the primary objects of the present invention to provide a device for use in lifting various sized tires.

Another object of the present invention is to provide a device which will enable a user to lift and position oversize tires for placement on a vehicle and which can be used to lower such tires from a vehicle to a floor.

Still another object of the present invention is to provide a device which can be used to lift heavy and cumbersome objects thereby minimizing back strain to the person completing such tasks.

Yet another object of the present invention is to provide a device for more easily maneuvering heavy tires into position for installation thereby saving time for a user of such device.

An additional object of the present invention is to provide a device which assists a user in accurately positioning a tire onto a wheel hub.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a partial perspective side view of the invention according to one embodiment of the invention.

FIG. 3 is a partial perspective view of the invention according to one embodiment of the invention; in this view, parts of the invention are shown disassembled from each other for clarity.

FIG. 4 is a partial perspective view of the invention according to one embodiment of the invention in which a tire is resting on the arms of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

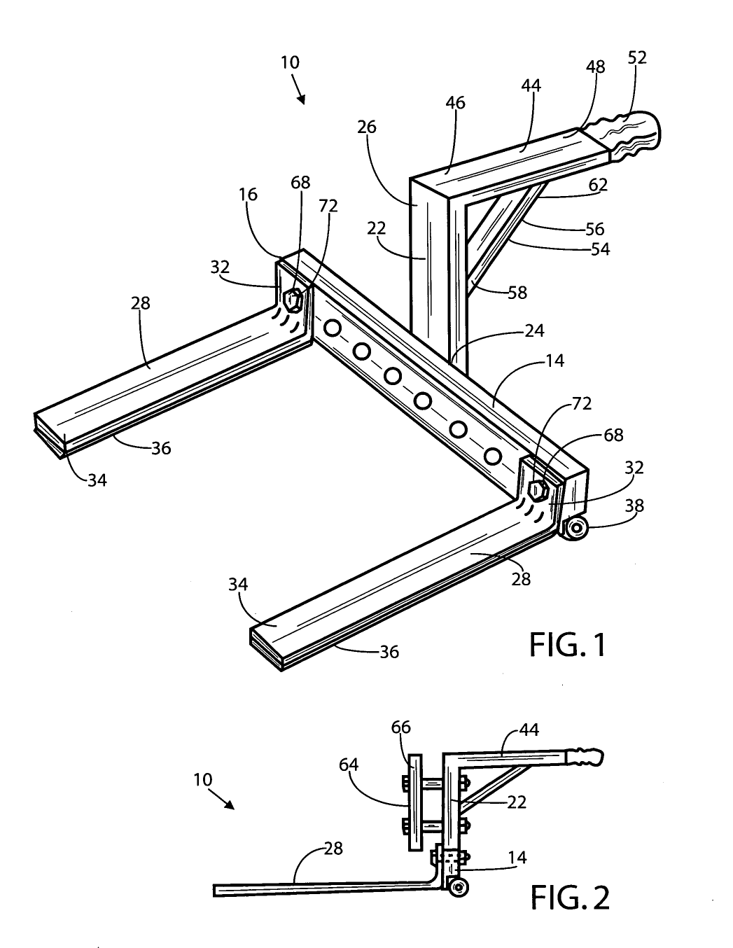

Reference is now made, more particularly, to FIGS. 1-4.

An apparatus, generally designated 10, for lifting, lowering, supporting, positioning and transporting a tire 12 is provided.

Such apparatus 10 includes a first generally horizontal frame member 14 having a first end 16 and a second end 18. Such first generally horizontal frame member 16 is manufactured from a first predetermined material and has a first predetermined size and a first predetermined shape.

It is presently preferred that such first predetermined material is a metal. It is presently preferred that such metal is at least one of aluminum and steel. It is presently most preferred that such metal is aluminum.

It is presently preferred that such first generally horizontal frame member 16 is between about 10.0 inches and about 22.0 inches long.

A first generally vertical frame member 22 has a first end 24 and a second end 26. Such first generally vertical frame member 22 is manufactured from a second predetermined material and has a second predetermined size and a second predetermined shape. The first end 24 of such first generally vertical frame member 22 is operably connected to the first generally horizontal frame member 16 at at least one predetermined location thereon. It is presently preferred that such first vertical frame member 22 is between about 24.00 inches and 30.00 inches long. Such vertical frame member 22 may be unshaped if desired or any other shape which is conducive to its purpose.

It is presently preferred that such second predetermined material is a metal. It is presently preferred that such metal is at least one of aluminum and steel. It is presently most preferred that such metal is aluminum.

A pair of arm members 28 each have a first end 32 and a second end 34. The arm members 28 are manufactured from a third predetermined material and have a third predetermined size and a third predetermined shape. Such arm members 28 are adjustably connectable at each of their respective first ends 32 to the first generally horizontal frame member 16 at predetermined locations thereon.

It is presently preferred that such third predetermined material is a metal. It is presently preferred that such metal is at least one of aluminum and steel. It is presently most preferred that such metal is aluminum.

It is presently preferred that such adjustable arm members, 28 each having a bottom exterior surface, each include a sliding means 36 operably disposed on such respective bottom exterior surfaces thereof for sliding such apparatus 10 across a floor. It is presently preferred that such sliding means 36 is plastic. Such plastic may be a coating of plastic applied to the entirety of such bottom surfaces or may be plastic sliding pieces operably connected to such bottom surfaces at predetermined location thereon for facilitating movement. Furthermore, as such arm members 28 are preferably manufactured from metal, such metal may be generally smooth such that the metal itself would facilitate sliding.

It is presently preferred that such apparatus 10 further includes a plurality of wheel members 38 operably disposed on a bottom surface of such first generally horizontal frame member 16 at predetermined locations thereon.

It is presently preferred that such apparatus 10 includes a second generally horizontal frame member 44 having a first end 46 and a second end 48 and such first end 46 thereof being operably connected to such second end 26 of such first vertical frame member 22 at a predetermined location thereon. Such second generally horizontal frame member 44 is manufactured from a fourth predetermined material and has a fourth predetermined shape and a fourth predetermined size. It is presently preferred that such first predetermined material, such second predetermined material and such fourth predetermined material are substantially identical.

It is presently preferred that such second generally horizontal frame member 44 is connected to such first vertical frame member 22 at a seventy degree angle. It is further presently preferred that such second generally horizontal frame member 44 is between about 18.00 inches and 22.00 inches long.

It is further presently preferred that such second generally horizontal frame member 44 includes a handle member 52 operably connected thereto at the second predetermined end 48 thereof.

As illustrated in FIG. 2, it is presently preferred that such apparatus 10 further includes a bracing means 54 operably connected to a predetermined location on at least one of the first generally horizontal frame member 14, the first generally vertical frame member 22, the second generally horizontal frame member 44 and a combination thereof.

It is presently preferred that the bracing means 54 is a bracing bar 56 having a first end 58 and a second end 62. Such bracing bar 56 is operably connected at such first end 58 thereof to a predetermined location on the first generally vertical member 22 and such bracing bar 56 is operably connected at such second end 62 thereof to a predetermined location on the second generally horizontal frame member 44.

It is presently preferred that such apparatus further includes a second generally vertical frame member 64 operably connected at a predetermined location thereon to at least one of the first generally horizontal frame member 14, the first generally vertical frame member 22, and a combination thereof. Such second generally vertical frame member 64 is meant to be, but is not to be limited to, a safety guard 66 that such tire 12 may rest against while being at least one of lifted, lowered, supported, positioned, and transported. It is presently preferred that such safety guard is between about 24.00 inches and about 28.00 inches long and between about 24.00 inches and about 28.00 high.

It is presently preferred that such apparatus 10 includes a means 68 for connecting each of the adjustable arm members 28 to a plurality of locations on such first generally horizontal frame member 14 such that a user (not shown) can adjust the distance between the adjustable arm members 28. It is presently preferred that such means 68 for connecting is at least one nut and bolt type fastener 72.

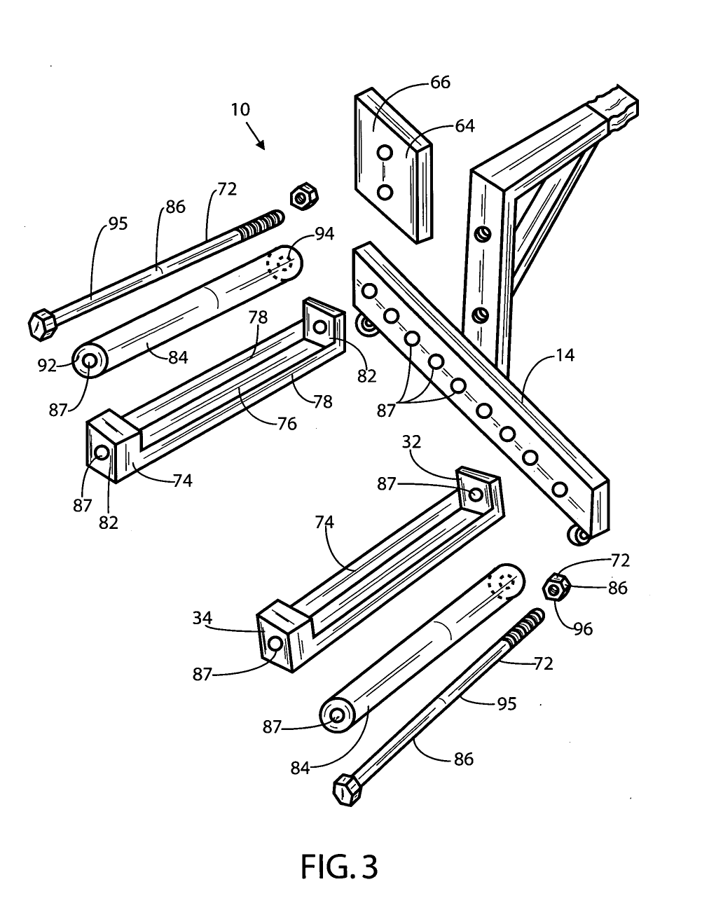

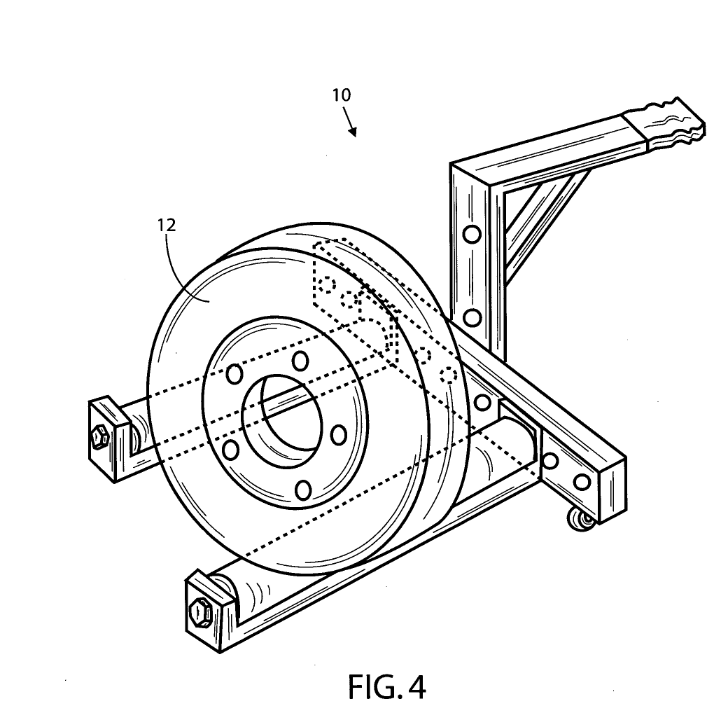

As illustrated in FIGS. 3-4, it is presently preferred that the third predetermined shape is channel shaped and such channel shaped adjustable arm members 74 each includes a bottom portion 76, two respective side portions 78, and two respective end portions 82. It is presently preferred that each of such channel shaped adjustable arm members 74 are between about 11.00 inches and 17.00 inches long. It is further presently preferred that each of the side portions of such channel shaped adjustable arm members 74 are between about 1.75 inches and 3.25 inches high.

It is further presently preferred that such apparatus 10 further includes a pair of rotatable elongate members 84 each being attached to a respective channel shaped adjustable arm member 74 at a predetermined location thereon by an attachment means 86. It is presently preferred that such rotatable elongate members 84 are each between about 10.0 inches and about 16.0 inches long. It is further presently preferred that such rotatable elongate members 84 have a diameter of between about 2.0 and 3.0 inches.

It is presently preferred that such first generally horizontal frame member 14 includes a plurality of apertures 87 disposed there through at predetermined locations thereon for receiving such at least one nut and bolt type fastener 72.

It is presently preferred that such channel shaped adjustable arm members 74 each include an aperture 87 disposed through a predetermined location on such first end 32 thereof and include an aperture 87 disposed through a predetermined location on such second end 34 thereof and further wherein each of the rotatable elongate members 84 include an aperture 87 disposed there through from a first predetermined end 92 thereof through a second opposite end 94 thereof, the apertures 87 being for receiving such at least one nut and bolt type fastener 72.

It is presently preferred that such at least one nut and bolt type fastener 72 includes a pair of elongated bolt members 95, each respective bolt member 95 being for inserting through each of the respective apertures 87 disposed on the second ends 34 of the channel shaped adjustable arm members 74 and then through the respective apertures 87 disposed through the first ends 92 through the second ends 94 of the rotatable elongate members 84 and then through the respective apertures 87 disposed through the first ends 32 of the channel shaped adjustable arm members 74 such that such bolt members 95 may then be threaded through each one of a respective predetermined aperture 87 disposed on the first generally horizontal frame member 14 and then each of such bolt members 95 secured with a respective nut type member 96.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. An apparatus for lifting, lowering, supporting, positioning and transporting a tire comprising;
a. a first generally horizontal frame member having a first end and a second end and being manufactured from a first predetermined material and having a first predetermined size and a first predetermined shape;
b. a first generally vertical frame member having a first end and a second end and being manufactured from a second predetermined material and having a second predetermined size and a second predetermined shape and said first end thereof being operably connected to said first generally horizontal frame member at at least one predetermined location thereon; and
c. a pair of arm members each having a first end and a second end, said arm members being manufactured from a third predetermined material and having a third predetermined size and a third predetermined shape and being adjustably connectable at each of said respective first ends thereof to said first generally horizontal frame member at predetermined locations thereon.

2. An apparatus for lifting, lowering, supporting, positioning and transporting a tire according to claim 1 wherein said apparatus further includes a plurality of wheel members operably disposed on a bottom surface of said first generally horizontal frame member at predetermined locations thereon.

3. An apparatus for lifting, lowering, supporting, positioning and transporting a tire according to claim 1 wherein said apparatus includes a second generally horizontal frame member having a first end and a second end and said first end thereof being operably connected to said second end of said first vertical frame member at a predetermined location thereon.

4. An apparatus for lifting, lowering, supporting, positioning and transporting a tire according to claim 1 wherein said apparatus includes a means for connecting each of said adjustable arm members to a plurality of locations on said first generally horizontal frame member such that a user can adjust the distance between said adjustable arm members.

5. An apparatus for lifting, lowering, supporting, positioning and transporting a tire according to claim 4 wherein said means for connecting is at least one nut and bolt type fastener.

6. An apparatus for lifting, lowering, supporting, positioning and transporting a tire according to claim 1 wherein said third predetermined shape is channel shaped and said channel shaped adjustable arm members each includes a bottom portion, two respective side portions, and two respective end portions.

7. An apparatus for lifting, lowering, supporting, positioning and transporting a tire according to claim 6 wherein said apparatus further includes a pair of rotatable elongate members each being attached to a respective channel shaped adjustable arm member at a predetermined location thereon by an attachment means.

8. An apparatus for lifting, lowering, supporting, positioning and transporting a tire according to claim 5 wherein said first generally horizontal frame member includes a plurality of apertures disposed therethrough at predetermined locations thereon for receiving said at least one nut and bolt type fastener.

9. An apparatus for lifting, lowering, supporting, positioning and transporting a tire according to claim 8 wherein said channel shaped adjustable arm members each include an aperture disposed through a predetermined location on said first end thereof and include an aperture disposed through a predetermined location on said second end thereof and further wherein each of said rotatable elongate members include an aperture disposed therethrough from a first predetermined end thereof through a second opposite end thereof, said apertures being for receiving said at least one nut and bolt type fastener.

10. An apparatus for lifting, lowering, supporting, positioning and transporting a tire according to claim 9 wherein said at least one nut and bolt type fastener includes a pair of elongated bolt members, each respective bolt member being for inserting through each of said respective apertures disposed on said second ends of said channel shaped adjustable arm members and then through said respective apertures disposed from said first end through said second end of said rotatable elongate members and then through said respective apertures disposed on said first ends of said channel shaped adjustable arm members such that said bolt members may then be threaded through each one of a respective predetermined aperture disposed on said first generally horizontal frame member and then each of said bolt members secured with a respective nut type member.

11. An apparatus for lifting, lowering, supporting, positioning and transporting a tire according to claim 7 wherein said rotatable elongate members are each between about 10.0 inches and about 16.0 inches long.

12. An apparatus for lifting, lowering, supporting, positioning and transporting a tire according to claim 1 wherein said first generally horizontal frame member is between about 10.0 inches and about 22.0 inches long.

13. An apparatus for lifting, lowering, supporting, positioning and transporting a tire according to claim 3 wherein said second generally horizontal frame member includes a handle member operably connected thereto at said second predetermined end thereof.

14. An apparatus for lifting, lowering, supporting, positioning and transporting a tire according to claim 3 wherein said apparatus further includes a bracing means operably connected to a predetermined location on at least one of said first generally horizontal frame member, said first generally vertical frame member, said second generally horizontal frame member and a combination thereof.

15. An apparatus for lifting, lowering, supporting, positioning and transporting a tire according to claim 1 wherein said first predetermined material is a metal.

16. An apparatus for lifting, lowering, supporting, positioning and transporting a tire according to claim 15 wherein said metal is at least one of aluminum and steel.

17. An apparatus for lifting, lowering, supporting, positioning and transporting a tire according to claim 17 wherein said metal is aluminum.

18. An apparatus for lifting, lowering, supporting, positioning and transporting a tire according to claim 1 wherein said adjustable arm members each having a bottom exterior surface each include a sliding means operably disposed on said respective bottom exterior surfaces thereof for sliding said apparatus across a floor.

19. An apparatus for lifting, lowering, supporting, positioning and transporting a tire according to claim 18 wherein said sliding means is plastic.

20. An apparatus for lifting, lowering, supporting, positioning and transporting a tire according to claim 3 wherein said apparatus further includes a second generally vertical frame member operably connected at a predetermined location thereon to at least one of said first generally horizontal frame member, said first generally vertical frame member, said second generally horizontal frame member and a combination thereof.
